(19) United States
(12) Patent Application Publication
(10) Pub. No.: US 2009/0144687 A1
(43) Pub. Date: Jun. 4, 2009

(54) Layout design method of semiconductor integrated circuit by using soft macro

(75) Inventor: Tetsuo Andou, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/292,802

(22) Filed: Nov. 26, 2008

(30) Foreign Application Priority Data
Nov. 29, 2007 (JP) 2007-308994

(51) Int. Cl. G06F 17/50

(52) U.S. Cl. 716/10

(57) ABSTRACT

A layout design method of a semiconductor integrated circuit to be formed in an integrated circuit (IC) chip is provided. The layout design method includes reading a netlist and a soft macro. The soft macro includes: relative position information describing relative positions of a plurality of relative arrangement position determined cells; and wiring information describing positions of arrangement position determined wiring lines arranged in corresponding to the plurality of relative position determined cells. The layout design method further includes: determining coordinates of the plurality of relative arrangement position determined cells in the IC chip based on the relative position information; determining wiring routes of the arrangement position determined wiring lines in the IC chip based on the coordinates and the wiring information; and determining an arrangement position of an arrangement position undetermined cell in the IC chip. The arrangement position undetermined cell is a cell of which arrangement position in the IC chip is undetermined in advance.

### INCORPORATION BY REFERENCE

This application is based upon and claims the benefit of priority from Japanese patent application No. 2007-308994, filed on Nov. 29, 2007, the disclosure of which is incorporated herein in its entirely by reference.

### BACKGROUND OF THE INVENTION

1. Field of the Invention

The present invention relates to a semiconductor integrated circuit, and more particularly, to a layout design method of semiconductor integrated circuit by using soft macro, a data structure of the soft macro, and a method for generating a soft macro library.

2. Description of Related Art

There is known a design method of a semiconductor integrated circuit by using soft or hard macro which describes a macro (functional module) as a function of the semiconductor integrated circuit.

The hard macro describes fixed arrangements of a plurality of primitive cells included in the macro and fixed wiring routes between the primitive cells. Information on the shape, input and output of the macro is provided to determine a chip layout. A layout tool can handle an internal configuration of the macro as a black box to determine the chip layout.

The soft macro describes how a plurality of primitive cells included in the macro are interconnected. The soft macro describes no fixed arrangement of the primitive cells and no fixed wiring route between the primitive cells. The soft macro and a netlist are provided to determine a chip layout. A layout tool determines arrangements of the primitive cells and the wiring routes between the primitive cells in the course of determination of chip layout.

When the hard macro is used to determine chip layout, other primitive cells not included in the macro described by the hard macro cannot be arranged in an area occupied by the macro. Also, wiring routes of wiring lines not included in the macro cannot be determined to extend through the area occupied by the macro. For this reason, wireability of chip may deteriorate, and chip area may be increased.

When the soft macro is used to determine chip layout, it is required to determine arrangements of the primitive cells included in the macro and to determine wiring routes between the primitive cells for every chip layout.

FIG. 1 is a flowchart illustrating a typical chip layout processing by using a soft macro. The chip layout processing is performed with the use of a layout tool and includes steps S11 to S15. In steps S11 and S12, an arrangement processing and a wiring processing are performed based on a soft macro library 110 as a library of the soft macro, a chip netlist 111, and chip timing information 112. In step S13, a timing verification is performed for a critical path in a macro described by the soft macro based on results of the steps S11 and S12. When the result of the verification is OK (Yes in step S14), chip layout information is outputted (step S15).

When the result of the verification is NG (No in step S14), the chip layout processing returns to the arrangement processing step S11 or the wiring processing step S12, and the steps S11 to S14 or the steps S12 to S14 are repeated until the result of the verification is OK (successful).

International Publication (WO 2000/49653) discloses a method for determining layout of a semiconductor integrated circuit by using hard and soft macros. FIG. 2 is a schematic diagram of an IP (Intellectual Property) module described in International Publication (WO 2000/49653). The IP module 101 includes a hard macro portion 102 described by hard macro and a soft macro portion 103 described by soft macro. With respect to circuits in the hard macro portion 102, timing is guaranteed. The soft macro portion 103 is formed between the hard macro portion 102 and external terminals of the IP module 101. By optimizing the soft macro portion 103 in consideration of loads with respect to circuits outside the macro and a performance of a chip, an increase in an area of the IP module 101 can be prevented as compared with a case in which all within the IP module 101 are described by hard macro. FIG. 3 illustrates IP module data 111 describing the IP module 101. IP module data 111 includes hard portion 112 describing the hard macro portion 102 and soft portion 113 describing the soft macro portion 103.

In the typical chip layout processing by using soft macro, when timing is critical, the arrangement processing step S11 or wiring processing step S12 is not completed at a first attempt in most cases. In such a case, in order to attain timing convergence for the critical path in the macro, a designer should repeatedly perform manual arrangement and wiring to carry out the layout, and consequently there arises a problem of an increase in design man-hour.

According to International Publication (WO 2000/49653), the IP module 101 includes the hard macro portion 102 for which the timing is guaranteed and the soft macro portion 103 for which a degree of design freedom is higher than that for the hard macro portion 102. Therefore, an increase in man-hour for determination of layout of the semiconductor integrated circuit is prevented.

The hard macro portion 102 arranged on the chip occupies a certain area of the chip. Primitive cells not included in the hard macro portion 102 are arranged not so as to overlap with the area occupied by the hard macro portion 102. Further, layout of primitive cells included in the hard macro portion 102 is determined in advance. For this reason, the layout of the primitive cells cannot be subject to optimization in the determination of chip layout. Accordingly, an area occupied by the IP module 101 in the chip depends on that occupied by the hard macro portion 102, and therefore there is a limitation to the reduction in the area occupied by the IP module 101.

Also, a net not included in the hard macro portion 102 is arranged with bypassing the hard macro portion 102. For this reason, wireability at a chip level may deteriorate. Further, wiring delay caused by the net bypassing the hard macro portion 102 may be increased and wiring congestion may appear.

### SUMMARY

In one embodiment, a layout design method of a semiconductor integrated circuit to be formed in an integrated circuit (IC) chip is provided. The layout design method includes reading a netlist and a soft macro. The soft macro includes: relative position information describing relative positions of a plurality of relative arrangement position determined cells; and wiring information describing positions of arrangement position determined wiring lines arranged in corresponding to the plurality of relative position determined cells. The layout design method further includes: determining coordinates of the plurality of relative arrangement position determined cells in the IC chip based on the relative position information; determining wiring routes of the arrangement position determined wiring lines in the IC chip based on the coordinates and the wiring information; and determining an arrangement position of an arrangement position undetermined cell in the IC chip. The arrangement position undetermined cell is a cell of which arrangement position in the IC chip is undetermined in advance.

In another embodiment, a method for generating a library is provided. The method for generating library includes: reading a macro netlist describing circuit information on a macro and macro timing information describing operation timing of the macro; determining a layout of the macro based on the macro netlist and the macro timing information; specifying a critical path as a path of the macro, in which signal delay is large, based on the layout of the macro and the timing information; extracting relative arrangement position determined cells as a plurality of functional cells included in the critical path; generating relative position information and wiring information respectively describing relative positions of the relative arrangement position determined cells and wiring lines arranged in corresponding to the relative position determined cells; and generating a soft macro library which includes the relative position information and the wiring information.

In another embodiment, a computer-readable medium which records a data structure of a soft macro for automated layout design of a semiconductor integrated circuit is provided. The data structure includes: relative arrangement position determined cell information specifying relative arrangement position determined cells of which relative arrangement positions are determined in advance; cell arrangement position relative coordinate information describing the relative arrangement positions; wiring position determined net information specifying wiring position determined nets of which relative wiring positions are determined in corresponding to the relative arrangement position determined cells in advance; and wiring position relative coordinate information describing the relative wiring positions. The data structure is configured such that a computer operates according to an automated layout program to execute an automated layout design method of a semiconductor integrated circuit to be formed in an integrated circuit (IC) chip by using the data structure. The automated layout design method includes: determining arrangements of the relative arrangement position determined cells in the IC chip based on the arrangement position determined cell information and the cell arrangement position relative coordinate information; and determining wiring routes of the wiring position determined nets based on the wiring position determined net information and the wiring position relative coordinate information.

Therefore, an increase in chip area can be suppressed. Also, when determining chip layout, number of layout repetitions for timing convergence and design man-hour can be reduced.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a flowchart illustrating a typical chip layout processing by using soft macro;

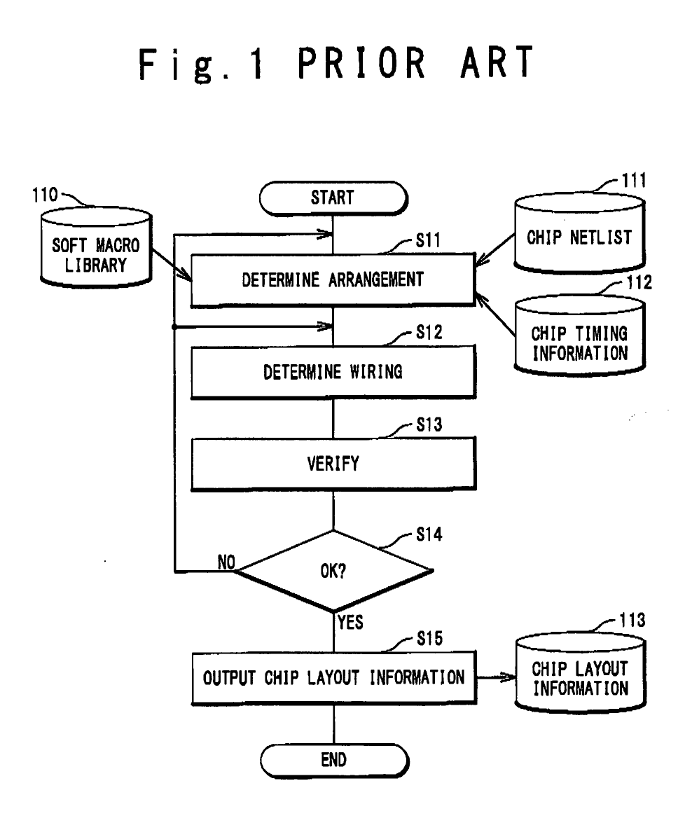

FIG. 2 is a schematic diagram of an IP module;

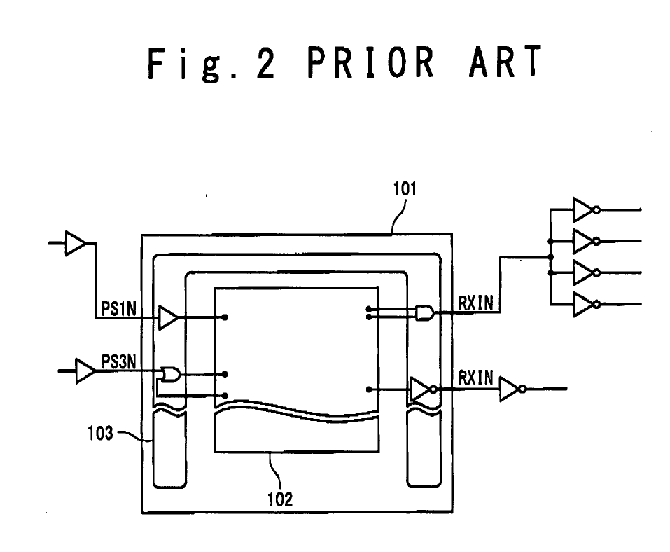

FIG. 3 illustrates IP module data describing the IP module;

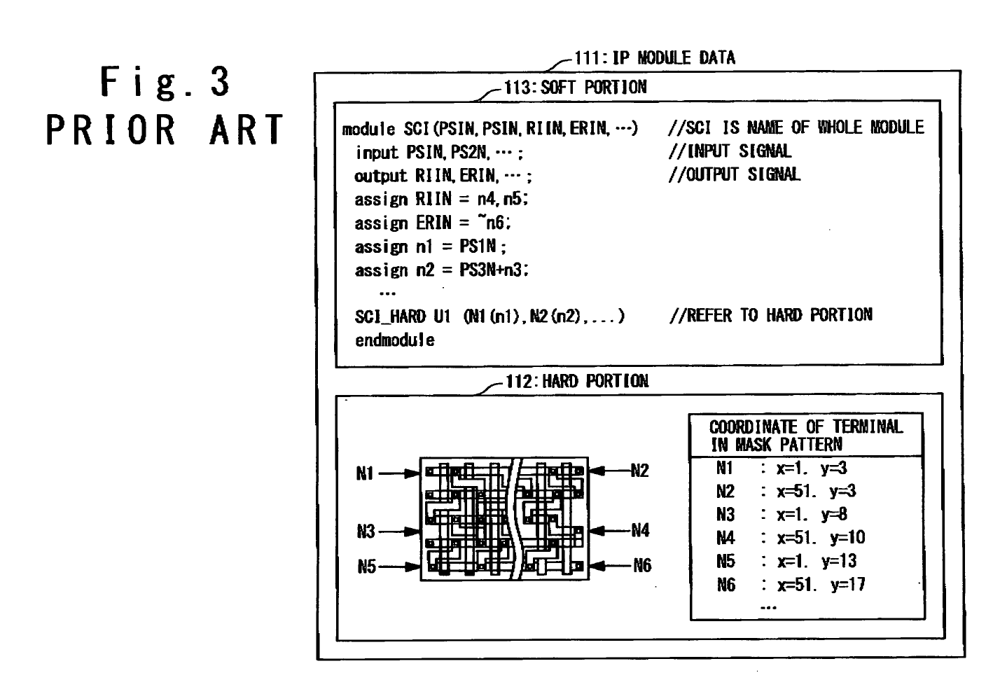

FIG. 4 is a block diagram of a semiconductor device design support system according to a first embodiment of the present invention;

FIG. 5 illustrates a data structure of a macro library according to the first embodiment;

FIG. 6 is a block diagram of a macro cell described by the macro library according to the first embodiment;

FIG. 7 is a flowchart of a method for generating the macro library;

FIG. 8 is a flowchart of a method for carrying out chip layout by using the macro library;

FIG. 9 is a plan view exemplifying a layout state;

FIG. 10 is a plan view exemplifying a layout state;

FIG. 11 is a plan view exemplifying a layout state;

FIG. 12 is a plan view exemplifying a macro cell according to a second embodiment of the present invention;

FIG. 13 exemplifies a data structure of a macro library corresponding to the macro cell according to the second embodiment;

FIG. 14 is a plan view exemplifying a macro cell according to a third embodiment of the present invention;

FIG. 15 exemplifies a data structure of a macro library corresponding to the macro cell according to the third embodiment;

FIG. 16 is a plan view exemplifying a macro cell according to a fourth embodiment of the present invention;

FIG. 17 exemplifies a data structure of a macro library corresponding to the macro cell according to the fourth embodiment;

FIG. 18 is a plan view exemplifying a macro cell according to a fifth embodiment of the present invention; and

FIG. 19 is a plan view exemplifying a macro cell according to a sixth embodiment of the present invention.

### DETAILED DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Referring to the attached drawings, a layout design method of semiconductor integrated circuit by using soft macro, a data structure of the soft macro, and a method for generating a soft macro library according to embodiments of the present invention will be described below.

### First Embodiment

According to a first embodiment of the present invention, layout of a semiconductor integrated circuit to be designed is determined with the use of a computer provided with a design support tool. The computer operates according to a procedure instructed by a computer program stored therein to thereby function as a design support tool.

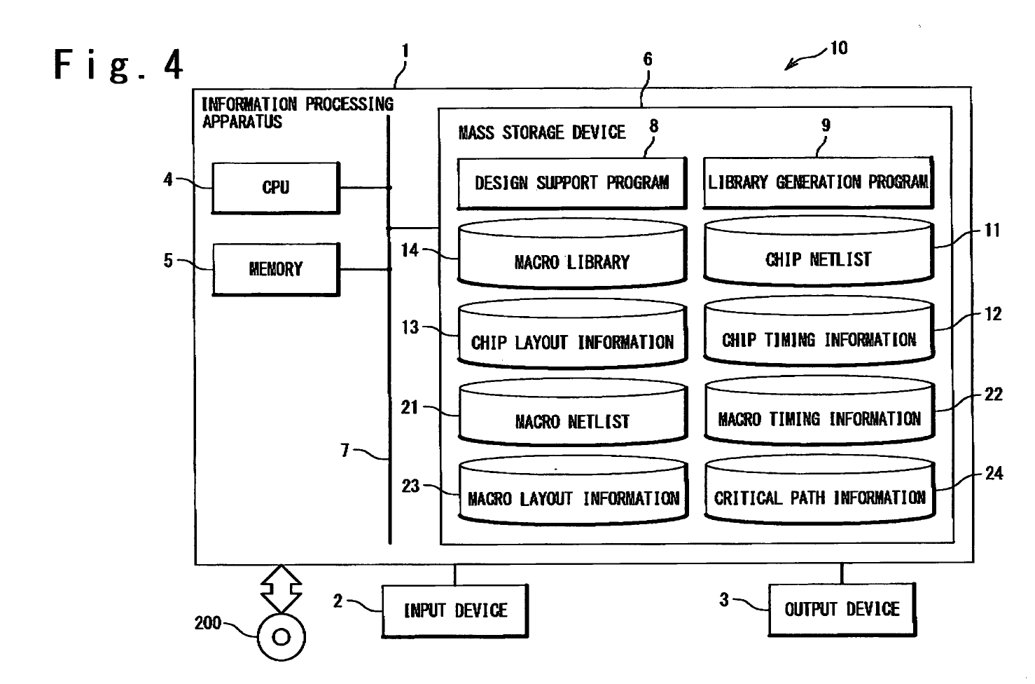

FIG. 4 is a block diagram of a semiconductor device design support system 10 according to the present embodiment. The semiconductor device design support system 10 includes an information processing apparatus 1, an input device 2, and an output device 3. The information processing apparatus 1 is a device (computer) which is caused by programs to execute a layout design method of semiconductor integrated circuit by using soft macro and a method for generating a soft macro library. The information processing apparatus 1 is provided with five basic functions, i.e., input, storage, calculation, control, and output. The input device 2 is a man-machine interface for inputting data to the information processing apparatus 1. A representative example of the input device 2 includes, for example, a keyboard, mouse, graphics tablet, touch panel, and the like. The output device 3 is a man-machine interface for externally outputting processing results from the information processing apparatus 1. A representative example of the output device 3 includes a display, a printer, and the like.

The information processing apparatus 1 is provided with a CPU 4, a memory 5, and a mass storage device 6, which are connected to one another through a bus 7. The CPU 4 is also referred to as a central processing unit, and performs control of various devices provided for the information processing apparatus 1 and data processing. The CPU 4 interprets data supplied through the input device 2 or the like to perform calculation, and outputs results of the calculation to the output device 3 or the like.

The memory 5 is a semiconductor memory such as a DRAM (Dynamic Random Access Memory), a SRAM (Static Random Access Memory), or the like. The memory 5 performs read-in of data in response to an instruction of the CPU 4. Also, the memory 5 performs read-out of data in response to an instruction of the CPU 4. Note that the memory 5 according to the present embodiment is not limited to the RAM (Random Access Memory). For example, the memory 5 may be an EEPROM (Electrically Erasable Programmable Read-Only Memory), a flash memory, or the like.

The mass storage device 6 is a storage device such as a HDD (Hard Disk Drive). The mass storage device 6 is provided with a function of retaining information even if externally supplied power is cut off. Note that the mass storage device 6 according to the present embodiment is not limited to the HDD. For example, the mass storage device 6 may be an EEPROM, a flash memory, or the like.

The mass storage device 6 stores a semiconductor device design support program 8, a library generation program 9, a chip netlist 11, chip timing information 12, chip layout information 13, a macro library 14, a macro netlist 21, macro timing information 22, macro layout information 23, and critical path information 24.

The design support program 8 describes a procedure for carrying out the layout of the semiconductor integrated circuit to be designed. The CPU 4 loads the design support program 8. In the present embodiment, the CPU 4 performs calculation and data processing according to the procedure described in the design support program 8, and thereby the information processing apparatus 1 function as a design support tool.

The library generation program describes a procedure for generating the macro library 14 according to the present embodiment. The CPU 4 loads the library generation program 9. In the present embodiment, the CPU 4 performs calculation and data processing according to a procedure described in the library generation program 9, and thereby the information processing apparatus 1 functions as a library generation device.

The chip netlist 11 includes circuit connection information describing how circuits are connected in the semiconductor integrated circuit to be designed. The chip timing information 12 includes circuit operation timing information describing operation timings of the circuits in the semiconductor integrated circuit to be designed. The chip layout information 13 is outputted as results from the information processing apparatus 1 when the information processing apparatus 1 operates according to the procedure described in the design support program 8.

The macro library 14 is referred to when a chip layout is determined. The macro library 14 includes layout information for specifying arrangements of cells (hereinafter referred to as “relative arrangement position determined cells”) in a circuit part in which timing is critical and positions of wiring lines (hereinafter referred to as “wiring position determined nets”) between the relative arrangement position determined cells. Also, layout of cells (hereinafter referred to as “arrangement position undetermined cells”) in a circuit part other than the circuit part in which timing is critical are not specified in the macro library 14 before the start of the determination of the chip layout. Similarly, layout of nets (hereinafter referred to as “wiring position undetermined nets”) in the circuit part other than the circuit part in which timing is critical are not specified before the start of the determination of the chip layout.

The macro library 14 may be generated by the information processing apparatus 1 and stored in a computer-readable medium 200 to be provided for another computer which executes a layout design method of semiconductor integrated circuit by using the macro library 14. The macro library 14 may be generated by another computer and stored in the medium 200 to be provided for the information processing apparatus 1 which executes a layout design method of semiconductor integrated circuit by using the macro library 14.

The macro netlist 21 is used to generate the macro library 14 according to the present embodiment. The macro netlist 21 includes circuit information on some functions of the semiconductor integrated circuit. The macro timing information 22 is used to generate the macro library 14 according to the present embodiment. The macro timing information 22 includes operation timing information on the functions of the semiconductor integrated circuit. The macro layout information 23 is generated in the course of generation of the macro library 14 according to the present embodiment. The macro layout information 23 describes layout in which arrangements of the cells in the circuit part of critical in timing and wiring lines between the cells are fixed. The critical path information 24 is generated in the course of generation of the macro library 14 according to the present embodiment. The critical path information 24 includes information on a path in the macro library 14.

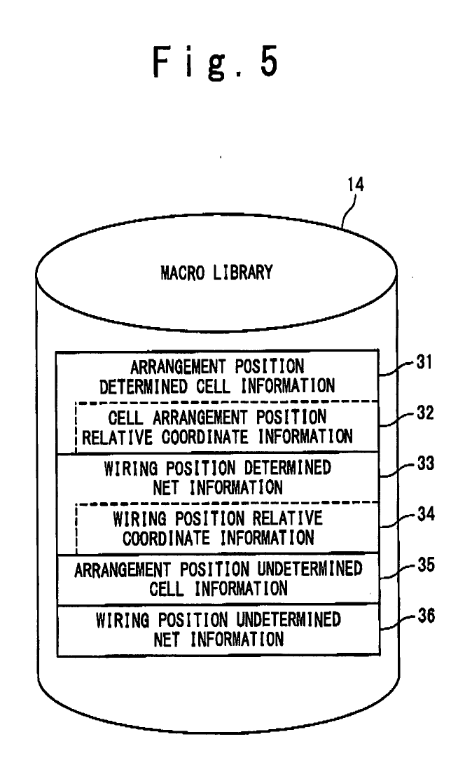

FIG. 5 is a block diagram exemplifying a data structure of the macro library 14 according to the first embodiment. Referring to FIG. 5, the macro library 14 includes arrangement position determined cell information 31, wiring position determined net information 33, arrangement position undetermined cell information 35, and wiring position undetermined net information 36. In the present embodiment, the macro library 14 is provided as a soft macro library.

The arrangement position determined cell information 31 includes information specifying the relative arrangement position determined cells. Also, the arrangement position determined cell information 31 includes cell arrangement position relative coordinate information 32. The cell arrangement position relative coordinate information 32 includes information on a relative positional relationship among the relative arrangement position determined cells. The wiring position determined net information 33 includes information specifying wiring position determined nets. Also, the wiring position determined net information 33 includes wiring position relative coordinate information 34. The wiring position relative coordinate information 34 includes information on a relative positional relationship among the wiring position determined nets. The arrangement position undetermined cell information 35 includes information on the arrangement position undetermined cells. The wiring position undetermined net information 36 includes information on the wiring position undetermined nets.

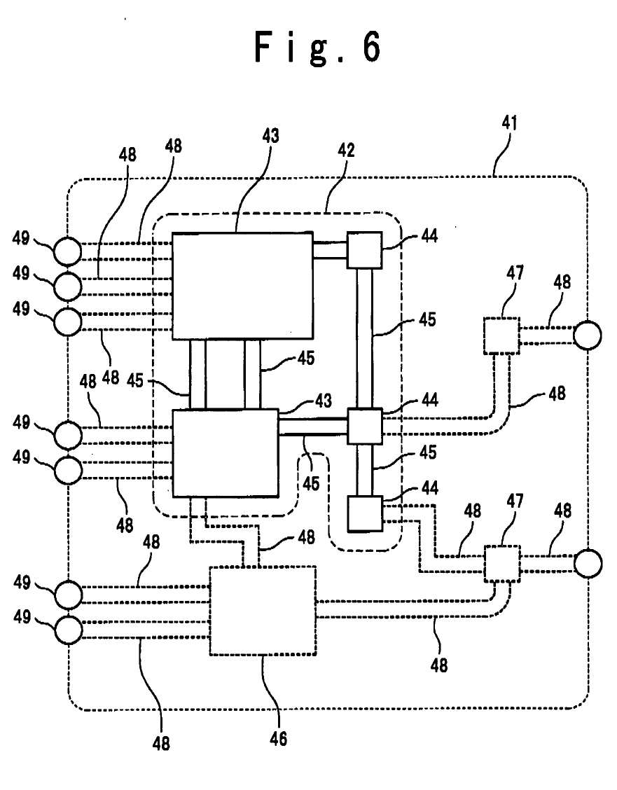

FIG. 6 is a block diagram of a macro cell 41 described by the macro library 14 according to the first embodiment. The macro cell 41 includes a relative arrangement position determined area 42. The relative arrangement position determined area 42 is provided with functional blocks 43 and primitive cells 44, which are connected to one another through wiring lines 45. Also, the macro cell 41 includes a functional block 46 and primitive cells 47. The arrangement position of the functional block 46 is undetermined. The arrangement positions of the primitive cells 47 are undetermined. Further, the macro cell 41 includes wiring position undetermined nets 48. Still further, the macro cell 41 according to the first embodiment includes I/O cells (input/output cells) 49. The macro cell 41 transmits and receives data through the I/O cells 49.

The position of the relative arrangement position determined area 42 in a chip can be changed. The functional blocks 43, the primitive cells 44, and the wiring lines 45 are included in the relative arrangement position determined area 42. The arrangement positions of the functional blocks 43, the primitive cells 44, and the wiring lines 45 are determined in advance to be fixed inside the relative arrangement position determined area 42. In other words, the relative positions of the functional blocks 43, the primitive cells 44, and the wiring lines 45 are determined in advance and fixed (or unchanged) in the course of design of chip layout.

The arrangement positions of the primitive cells 47 in the macro cell 41 are not determined in advance but determined in the course of the design of chip layout. The arrangement positions of the wiring position undetermined nets 48 in the macro cell 41 are determined in the course of the design of chip layout.

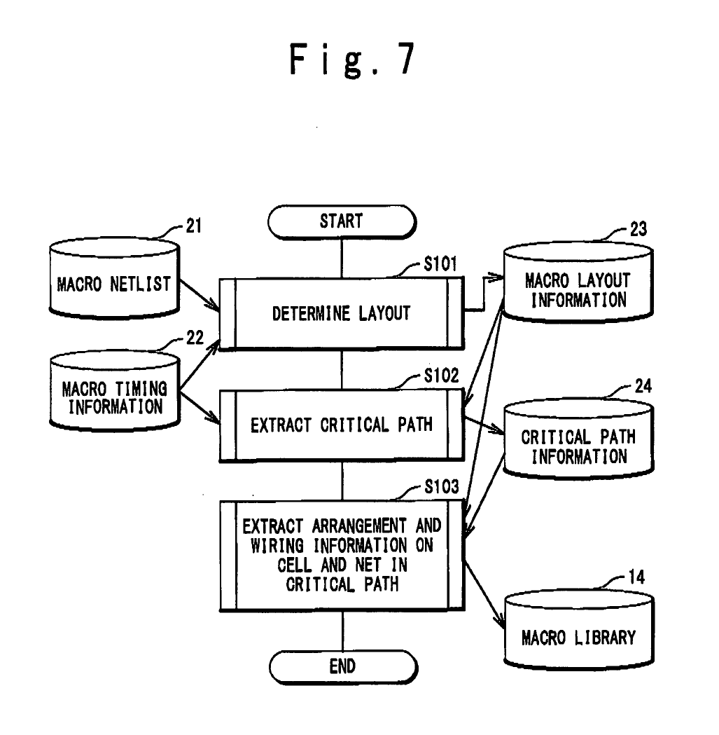

FIG. 7 is a flowchart exemplifying an operation (or a method) for generating the macro library 14 describing the configuration of the macro cell 41. The information processing apparatus 1 executes Steps S101 to S103 to carry out the method for generating the macro library 14. In Step S101, the macro netlist (circuit connection information) 21 and the macro timing information 22 are inputted into a layout process (layout tool). The layout tool reads the macro netlist 21 describing circuit information on the macro cell 41 and the macro timing information 22 describing operation timing of the macro cell 41. The layout tool performs arrangement and wiring for cells constituting the macro based on the macro netlist 21, and outputs results of the arrangement and the wiring as the macro layout information 23. In this way, the layout tool determines a layout of the macro cell 41 based on the macro netlist 21 and the macro timing information 22, and outputs the macro layout information 23 describing the layout.

In Step S102, the macro timing information 22 and macro layout information 23 are inputted to a critical path extraction process (critical path extraction tool). The critical path extraction tool specifies a critical path as a path of the macro cell 41, in which timing is critical and signal delay is large, based on the layout of the macro cell 41 described in the information 23 and the macro timing information 22. The critical path extraction tool extracts functional cells included in the critical path and nets between the cells. The extracted cells are the arrangement position determined cells 43 and 44. The nets between the cells are included in the critical path. The extracted nets are the wiring lines 45. The critical path extraction tool outputs results of the extraction as the critical path information 24.

In Step S103, the macro layout information 23 and critical path information 24 are inputted to an arrangement/wiring information extraction process (tool). The arrangement/wiring information extraction tool specifies a configuration of the relative arrangement position determined area 42 including the functional blocks 43, the primitive cells 44, and the wiring lines 45, based on information on the cells and the nets included in the critical path. The arrangement/wiring information extraction tool generates the macro library 14 describing the macro cell 41 having the relative arrangement position determined area 42, the primitive cells 47 of which the arrangement positions are undetermined and the wiring position undetermined nets 48, and stores the macro library 14 in the mass storage device 6.

At this time, the cell arrangement position relative coordinate information 32 describing relative arrangement positions of the cells included in the relative arrangement position determined area 42, and the wiring position relative coordinate information 34 describing relative positions of the net wiring lines included in the relative arrangement position determined area 42 are generated and stored in the macro library 14. For example, a file in a DEF format can be employed for the macro library 14.

Consequently, the generated pieces of information included in the macro library 14 are as follows. The arrangement position determined cell information 31 specifies the relative arrangement position determined cells 43 and 44 of which relative arrangement position are determined in advance. The cell arrangement position relative coordinate information 32 describes the relative arrangement positions. The wiring position determined net information 33 specifies the wiring position determined nets 45 of which relative wiring positions are determined in corresponding to the relative arrangement position determined cells 43 and 44 in advance. The arrangement position determined wiring lines 45 are arranged in corresponding to the relative arrangement position determined cells 43 and 44. The wiring position relative coordinate information 34 describes the relative wiring positions.

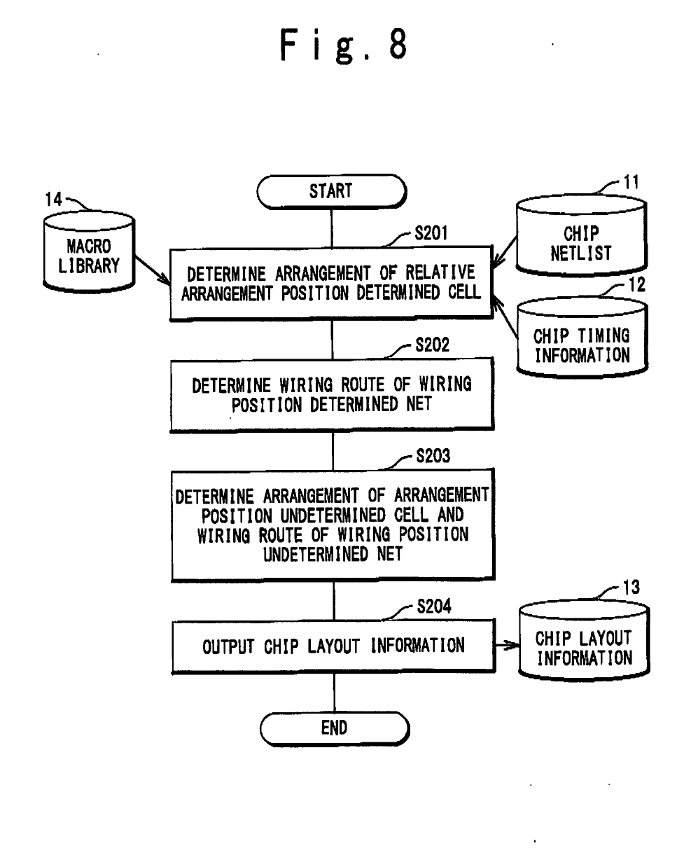

FIG. 8 is a flowchart exemplifying an operation for carrying out the design of chip layout by using the macro library 14 according to the present embodiment. The operation for carrying out the design of chip layout is performed in such a way that the CPU 4 reads the design support program 8 and operates according to a procedure described in the design support program 8 as described below. The information processing apparatus 1 executes Steps S201 to S204 to carry out the layout design method of semiconductor integrated circuit.

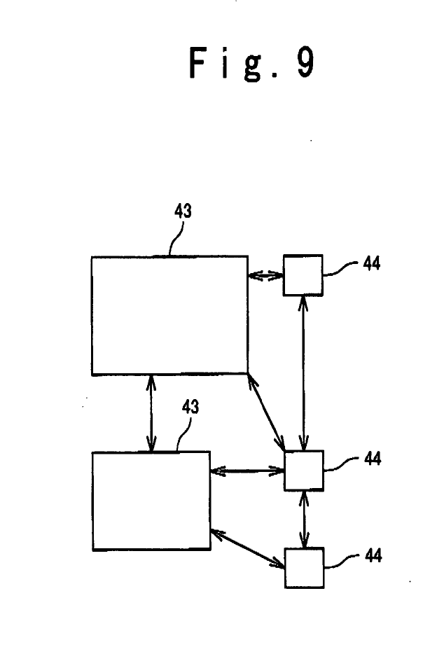

In Step S201, the macro library 14, the chip netlist 11, and the chip timing information 12 are inputted to a layout process (layout tool). The layout tool reads the macro library 14, the chip netlist 11, and the chip timing information 12. The layout tool determines arrangement positions (or coordinates) of the functional blocks 43 and the primitive cells 44 as the relative arrangement position determined cells in a chip based on the arrangement position determined cell information 31 and the cell arrangement position relative coordinate information 32 in the macro library 14. The chip is, for example, an IC (Integrated Circuit) chip. FIG. 9 is a plan view exemplifying a layout state after the process in Step S201 has been performed. The relative positions of the functional blocks 43 and primitive cells 44 are determined.

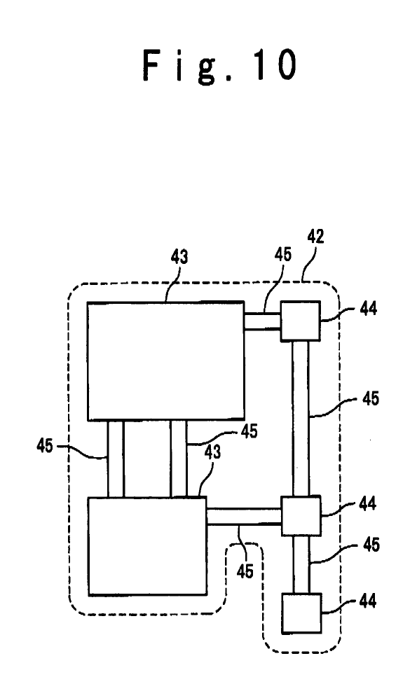

In Step S202, the layout tool determines wiring positions (or wiring routes) of the wiring lines 45 as the wiring position predetermined nets in the chip, based on the determined coordinates of the cells 43 and 45, the wiring position determined net information 33 and the wiring position relative coordinate information 34 in the macro library 14. FIG. 10 is a plan view exemplifying a layout state after the process in Step S202 has been performed. The wiring routes of the wiring lines 45 are determined based on the positions of the functional blocks 43 and the primitive cells 44. Also, in response to the determination of the arrangements of the functional blocks 43, the primitive cells 44, and the wiring lines 45, layout of the relative arrangement position determined area 42 is determined.

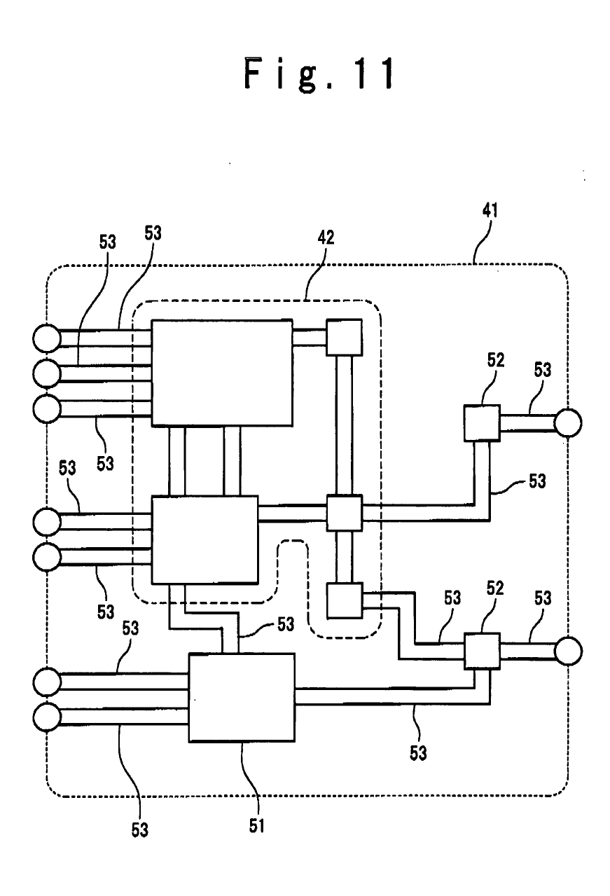

In Step S203, based on the arrangement position undetermined cell information 35 and the wiring position undetermined net information 36 in the macro library 14, the chip net list 11, and the chip timing information 12, the layout tool determines arrangements of the functional block 46 and the primitive cells 47 of which the arrangement positions have not been determined. In this way, the arrangement positions of the functional block 46 and the primitive cells 47 in the chip are determined. The functional block 46 and the primitive cells 47 are the arrangement position undetermined cells of which arrangement position in the chip are undetermined in advance. Also, the layout tool determines wiring positions (or wiring routes) of the wiring position undetermined net 48. In Step S204, the layout tool carries out layout of cells and nets outside the macro cell 41 at the same time, and the chip layout information 13 is outputted to complete the design of chip layout. FIG. 11 is a plan view exemplifying a configuration of the macro cell 41 after the process in Step S204 has been completed. After the arrangement of the relative arrangement position determined area 42 is determined, the positions of the functional block 46 and the primitive cells 47 of which the arrangement positions have not been determined are determined. After the determination of the positions, the functional block 46 is referred to as a layout completed functional block 51 and the primitive cells 47 are referred to as layout completed primitive cells 52, as shown in FIG. 11. The wiring routes of the wiring position undetermined nets 48 of which the wiring positions have not been determined are determined. After the determination of the wiring routes, the nets 48 are referred to as layout completed wiring lines 53, as shown in FIG. 11.

In the relative arrangement position determined area 42 that is the circuit part in which timing is critical in the macro library 14, the arrangements and wirings are fixed prior to the design of chip layout. The layout of the relative arrangement position determined area 42 is not changed in the course of layout of the chip.

Also, in case that a plurality of macro cells 41 are mounted on a chip and in case that a macro cell 41 is mounted on each of a plurality of chips, the arrangements and wirings in the relative arrangement position determined area 42 are not changed.

Also, upon layout of the chip, the arrangements of the functional block 46 and the primitive cells 47 are determined simultaneously with the layout of the cells outside the macro cell 41. At this time, the functional block 46 and the primitive cell 47 can be arranged at optimum positions in the chip without considering an area of the macro cell 41. Accordingly, the chip size can be reduced as compared with a case that all of the cells included in the macro cell 41 are the relative arrangement position determined cells.

Also, the wiring routes of the wiring position undetermined nets 48 and nets outside the macro cell 41 can be determined without considering the area of the macro cell 41. Accordingly, deterioration in wireability, increase in wiring delay, and wiring congestion can be alleviated, and the number of layout repetitions for timing convergence and design man-hour can be reduced.

### Second Embodiment

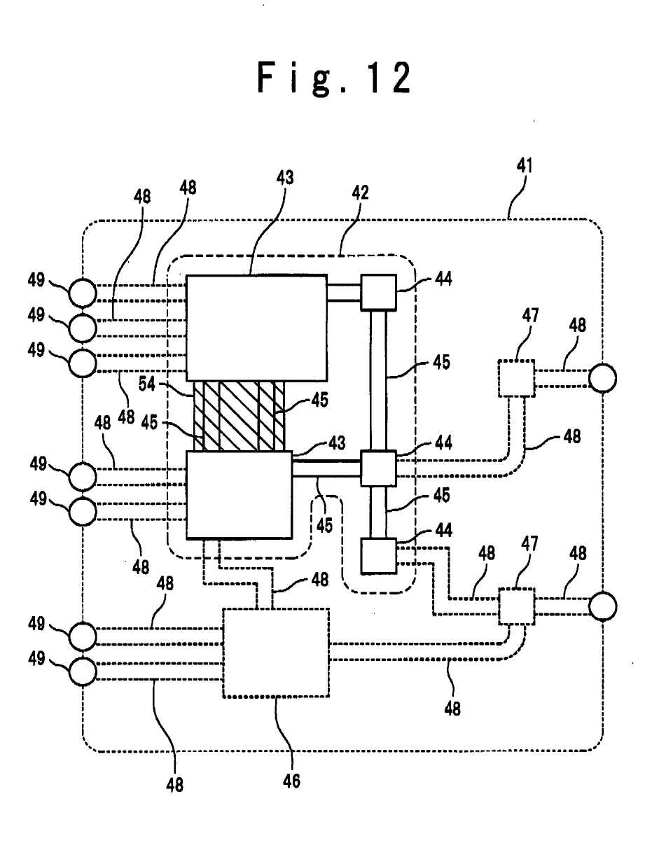

A second embodiment of the present invention is described below referring to the drawings. FIG. 12 is a plan view exemplifying a configuration of a macro cell 41 according to the second embodiment. Configuration and operation of a semiconductor device design support system 10 according to the second embodiment are same as those of the system 10 according to the first embodiment, but may be modified as necessary to suit the macro cell 14 according to the second embodiment. In the following descriptions, to facilitate understanding of configuration and operation according to the present embodiment, a duplicate description of a same portion as that of the above-described embodiment is omitted.

Referring to FIG. 12, the macro cell 41 according to the second embodiment includes a wiring prohibited area 54. The wiring prohibited area 54 is provided around functional blocks 43, primitive cells 44, and wiring lines 45 in relative arrangement position determined area 42, and configured such that another net wiring lines are not arranged therein.

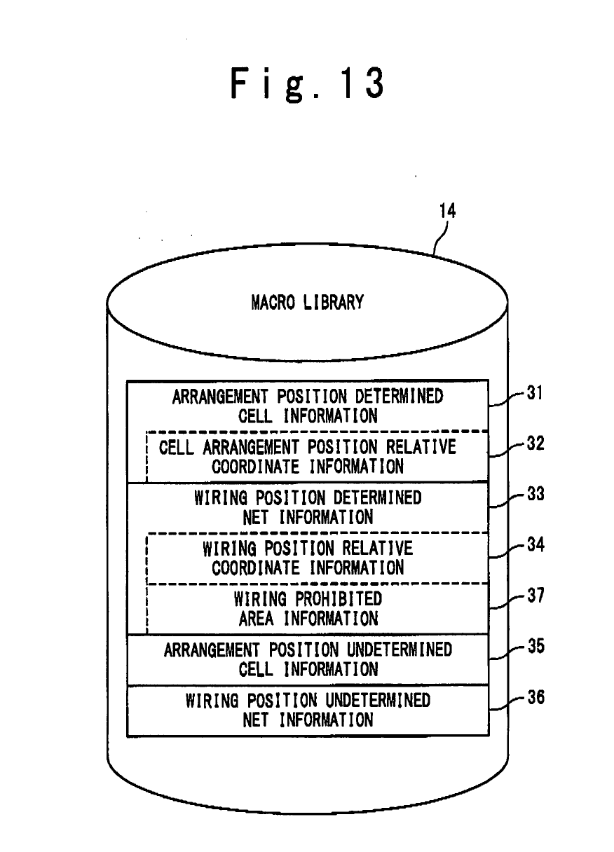

FIG. 13 exemplifies a data structure of a macro library 14 corresponding to the macro cell 41 according to the second embodiment. As illustrated in FIG. 13, the macro library 14 according to the second embodiment has wiring prohibited area information 37 in wiring position determined net information 33. The wiring prohibited area information 37 describes the wiring prohibited area 54 in which a wiring line other than arrangement position determined nets 45 is from being arranged. The wiring prohibited area information 37 is generated in Step S103. In step S203, arrangement positions of arrangement position undetermined cells 46 and 47 and wiring routes of wiring lines 48 are determined such that the arrangement positions of arrangement position undetermined cells 46 and 47 are not included in the wiring prohibited area 54 described by the wiring prohibited area information 37 and the wiring routes of the wiring lines 48 bypasses the wiring prohibited area 54. The macro cell 41 according to the second embodiment can provide effects of preventing nets for which wiring routes are determined and timing is guaranteed from being influenced by other net wiring lines to surely guarantee the timing, and reducing the number of layout repetitions for timing convergence and design man-hour in the course of the design of chip layout,

### Third Embodiment

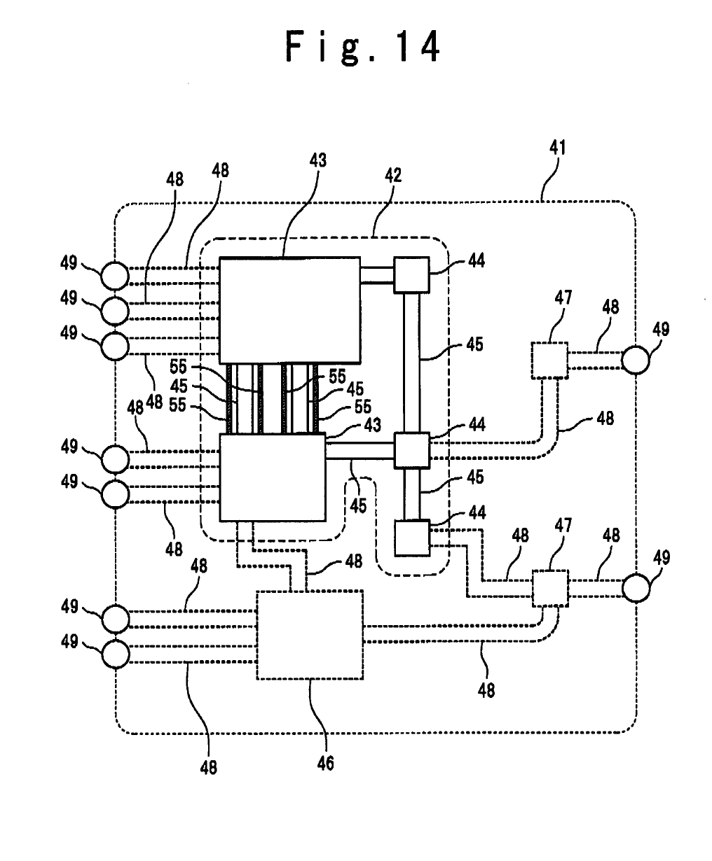

A third embodiment of the present invention is described below referring to the drawings. FIG. 14 is a plan view exemplifying a configuration of a macro cell 41 according to the third embodiment. Configuration and operation of a semiconductor device design support system 10 according to the third embodiment are same as those of the system 10 according to the first embodiment, but may be modified as necessary to suit the macro cell 14 according to the third embodiment. In the following descriptions, to facilitate understanding of configuration and operation according to the present embodiment, a duplicate description of the same portion as those of the above-described embodiments is omitted. Referring to FIG. 14, the macro cell 41 according to the third embodiment includes shielding lines 55. The shielding lines 55 suppress wiring lines 45 in relative arrangement position determined area 42 from influencing other net wiring lines.

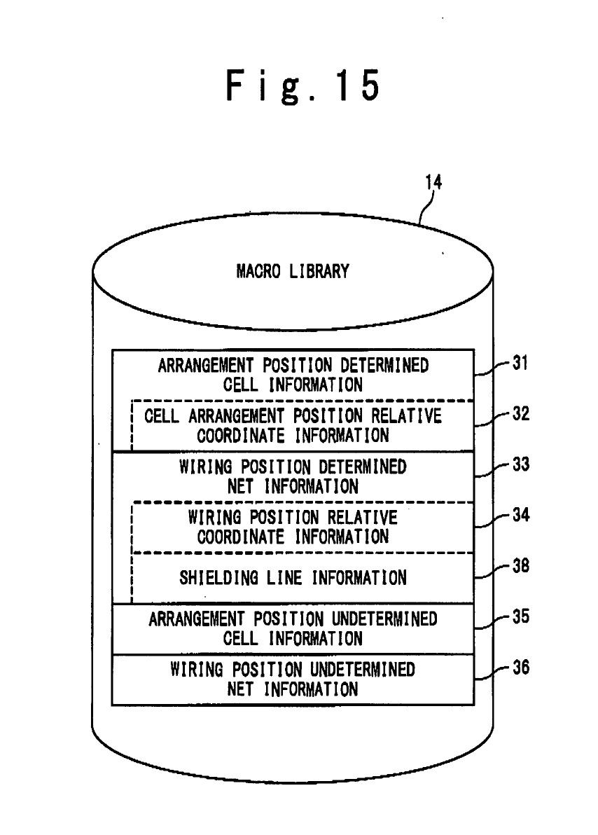

FIG. 15 exemplifies a data structure of a macro library 14 corresponding to the macro cell 41 according to the third embodiment. As illustrated in FIG. 15, the macro library 14 according to the third embodiment has shielding line information 38 in wiring position determined net information 33. The shielding line information 38 describes the shielding lines 55 provided for wiring position determined nets 45. The shielding lines 55 are provided for suppressing influences of the wiring lines 45 arranged in corresponding to relative position determined cells 43 on other nets. In step 103, the shielding line information 38 is generated. In Step S202, wiring routes of the shielding lines 55 are determined based on the shielding line information 38 such that the shielding lines 55 shields the wiring position determined nets 45. This can eliminates the influence of the nets for which wiring routes are determined on other net wiring lines, and therefore provide effects of reducing the number of layout repetitions for timing convergence and design man-hour in the course of the design of chip layout.

### Fourth Embodiment

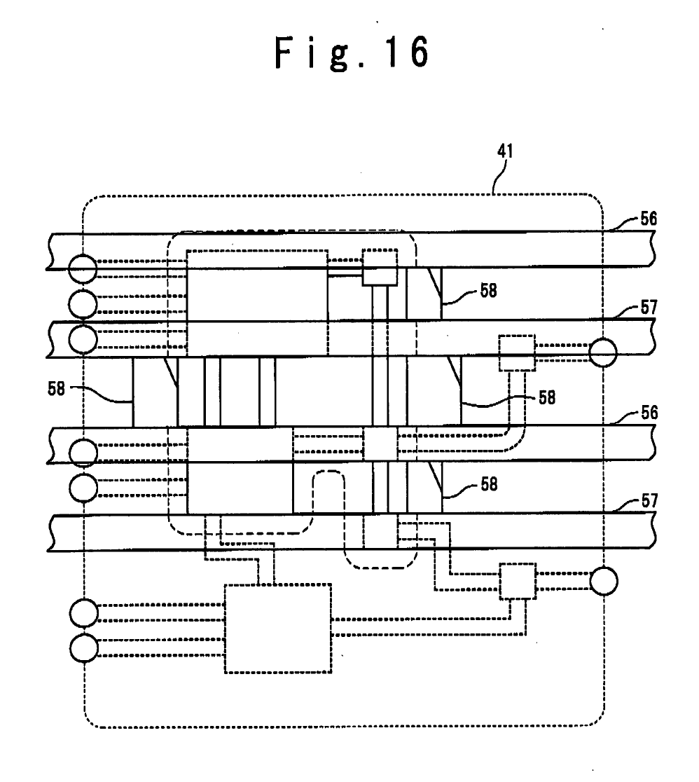

A fourth embodiment of the present invention is described below referring to the drawings. FIG. 16 is a plan view exemplifying a configuration of a macro cell 41 according to the fourth embodiment. Configuration and operation of a semiconductor device design support system 10 according to the fourth embodiment are same as those of the system 10 according to the first embodiment, but may be modified as necessary to suit the macro cell 14 according to the fourth embodiment. In the following descriptions, to facilitate understanding of configuration and operation according to the present embodiment, a duplicate description of the same portion as those of the above-described embodiments is omitted.

Referring to FIG. 16, the macro cell 41 according to the fourth embodiment includes decoupling capacitors 58 arranged between power lines 56 and ground lines 57. The decoupling capacitors 58 are configured depending on operating frequencies of the functional blocks 43 and the primitive cells 44 in relative arrangement position determined area 42. The decoupling capacitors 58 reduce influence of cells arranged around the relative arrangement position determined area 42 on the area 42, as well as reducing influence of the relative arrangement position determined area 42 on the cells around the area 42.

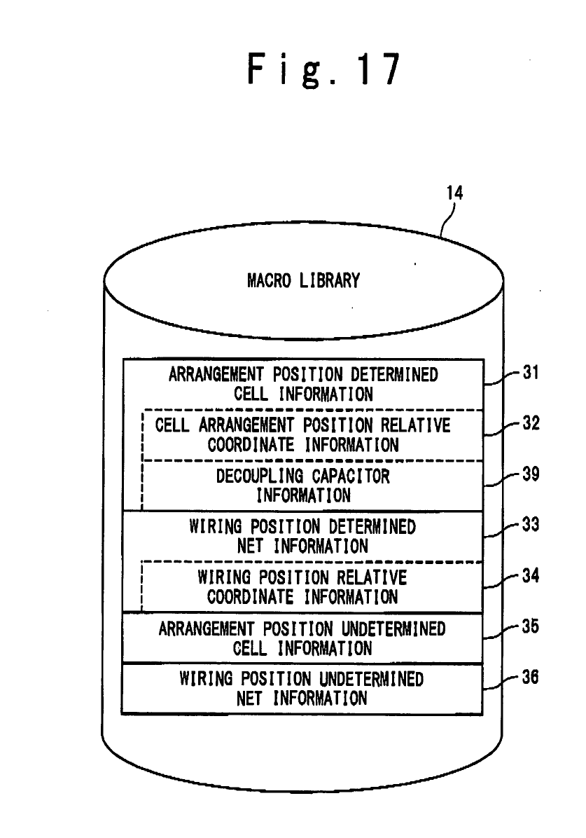

FIG. 17 exemplifies a data structure of a macro library 14 corresponding to the macro cell 41 according to the fourth embodiment. As illustrated in FIG. 17, the macro library 14 according to the fourth embodiment has decoupling capacitor information 39 in the arrangement position determined cell information 31. The decoupling capacitor information 39 describes the decoupling capacitors 58 for reducing influence of relative arrangement position determined cells 43 and 44 on other functional cells or/and influence of the other functional cells on the cells 43 and 44. In step s103, the decoupling capacitor information 39 is generated. A step in which positions of the decoupling capacitors 58 for the lines 56 and 57 are determined based on the decoupling capacitor information 39 is added to Steps S201 to S204. This can reduce influence of power-supply noise from other arranged cells on the relative arrangement position determined cells and power-supply noise generated during operation of the relative arrangement position determined cells, and therefore provide an effect of a preventing false operation due to the power-supply noise during actual operation.

### Fifth Embodiment

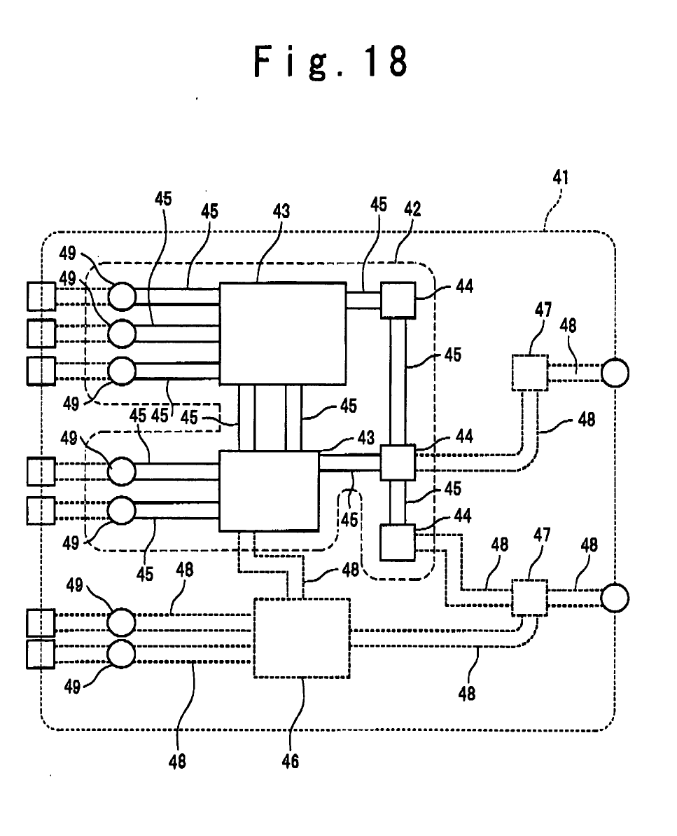

A fifth embodiment of the present invention is described below referring to the drawings. FIG. 18 is a plan view exemplifying a configuration of the macro cell 41 according to the fifth embodiment. Configuration and operation of a semiconductor device design support system 10 according to the fifth embodiment are same as those of the system 10 according to the first embodiment, but may be modified as necessary to suit the macro cell 14 according to the fifth embodiment. In the following descriptions, to facilitate understanding of configuration and operation according to the present embodiment, a duplicate description of the same portion as those of the above-described embodiments is omitted. Referring to FIG. 18, the macro cell 41 according to the fifth embodiment is provided with relative arrangement position determined area 42 including I/O cells 49 of which arrangement positions are determined. Between the I/O cells 49 and the functional block 43, wiring lines 45 are arranged. In Step S201, coordinates of macro cells 43 and the I/O cells 49 in the IC chip are determined based on relative position information 32. In Step S202, a wiring route of wiring line 45 for connecting the macro cell 43 and the I/O cell 49 in the IC chip is determined based on wiring information 34 and the coordinates of macro cell 43 and the I/O cell 49.

### Sixth Embodiment

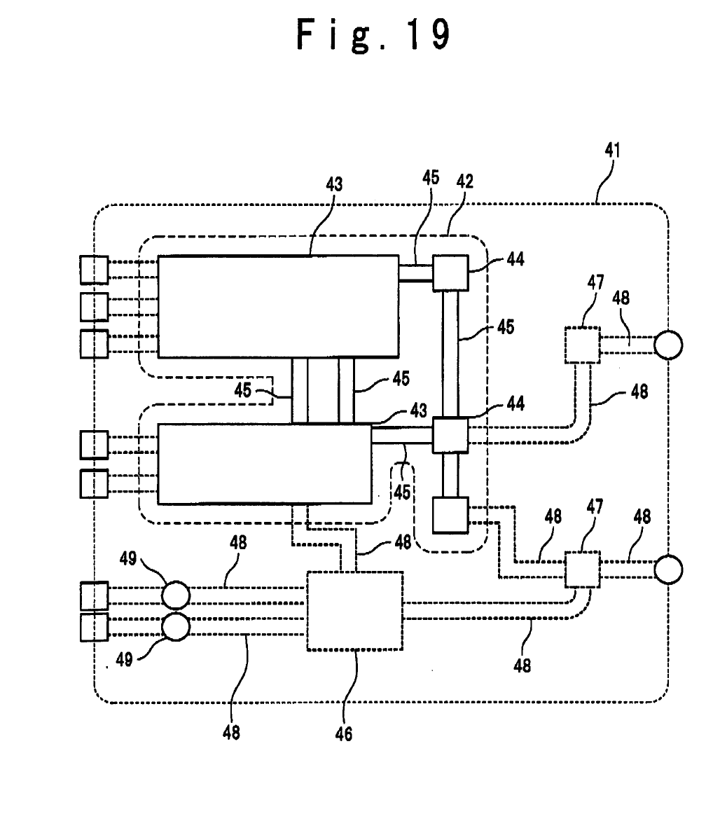

A sixth embodiment of the present invention is described below referring to the drawings. FIG. 19 is a plan view exemplifying a configuration of a macro cell 41 according to the sixth embodiment. Configuration and operation of a semiconductor device design support system 10 according to the fifth embodiment are same as those of the system 10 according to the first embodiment, but may be modified as necessary to suit the macro cell 14 according to the sixth embodiment. In the following descriptions, to facilitate understanding of configuration and operation according to the present embodiment, a duplicate description of the same portion as those of the above-described embodiments is omitted. Referring to FIG. 19, in the macro cell 41 according to the sixth embodiment, the relative arrangement position determined area 42 is provided with the functional blocks 43 including the I/O cells 49 of which arrangement positions are determined. Between the functional blocks 43, the wiring lines 45 are arranged. The functional blocks 43 including the I/O cells 49 may be referred to as I/O macros 43. In step S201, coordinates of the I/O macros 43 in the IC chip are determined based on relative position information 32. In Step S202, wiring routes of wiring lines 45 connected to the I/O macro 43 in the IC chip is determined based on wiring information 34 and the coordinates of the I/O macro 43.

It is apparent from the fifth and sixth embodiments that the functional blocks 43 and primitive cells 44 included in the relative arrangement position determined area 42 are not limited to primitive cells but may be any types of cells such as I/O cell and RAM. Moreover, in the above-described embodiments, the macro library 14 may be configured to have wiring prohibition information for prohibiting wiring lines from being arranged in an area corresponding to the relative arrangement position determined area 42.

When determining the chip layout based on the macro library 14, the timing is guaranteed in the relative arrangement position determined area 42. The macro library 14 does not impose restrictions on arrangement and wiring positions for cells and nets in a circuit part other than the relative arrangement position determined area 42. Accordingly, when determining the chip layout, cells described and not described by soft macro can be respectively arranged at optimum positions without limitation relevant to an area described by soft macro. Therefore, an increase in a chip area can be prevented as compared with the case of hard macro. Also, a wiring route of a net which is not described by the soft macro can be arranged with using an area described by soft macro. Therefore, reduction in wireability, increase in wiring delay, and wiring congestion, which are caused when the wiring route of the net not described by soft macro bypasses the area described by soft macro, can be prevented. In particular, a hard macro is provided for each of functionally organized functional modules. According to the embodiments, a soft macro fixes arrangement for a portion of a functional module, in which timing is critical, but the soft macro permits free arrangement for a portion of the functional module, in which timing is not critical. Therefore, a higher degree of freedom in design is provided.

Further, in recent years, a wiring pitch becomes narrower, and therefore influence of cross talk between signals is not ignorable. In the above related art, a hard macro is provided in which wiring route is determined in advance for a net of critical timing in a macro, and therefore timing is guaranteed for the net. However, there is a problem as follows. In design of chip layout, a wiring route of a net not included in the macro may be determined to be arranged near the wiring route of the net of critical timing in the macro. In that case, the timing for the net of critical timing may be changed due to cross talk caused by a signal in the net not included in the macro.

Still further, since the timing for the net of critical timing may be changed due to cross talk, there is another problem that many time repetition of layout design is needed to attain timing convergence.

According to the embodiments, arrangements and wiring routes are determined in advance only for a circuit part of a circuit described by a soft macro, in which timing restriction is severe, whereas a netlist is only prepared for a circuit part of the circuit described by the soft macro, in which timing restriction is not severe.

Therefore, increase in chip area can be suppressed. Also, when determining chip layout, number of layout repetitions for timing convergence and design man-hour can be reduced.

The soft macro according to the embodiments includes physical information on layout only for a circuit part in which timing is critical. The physical information on layout describes fixed arrangement of cells and fixed wiring routes between the cells. When the soft macro further includes the wiring prohibited area information above described, a wiring route of a net not described by the soft macro can be prevented to be arranged near a wiring route of a net described by the soft macro, for which timing is critical. Consequently, timing can be guaranteed for the net described by soft macro, for which timing is critical.

Further, the timing can be guaranteed for the net for which timing is critical when determining chip layout, and this facilitates layout design for timing convergence. Therefore, design man-hour can be reduced and also increase in chip size can be prevented.

It is apparent that the present invention is not limited to the above embodiments, but may be modified and changed without departing from the scope and spirit of the invention. For example, the above embodiments can be combined arbitrarily.

What is claimed is:

1. A layout design method of a semiconductor integrated circuit to be formed in an integrated circuit (IC) chip, comprising:
reading a netlist and a soft macro, wherein said soft macro includes relative position information describing relative positions of a plurality of relative arrangement position determined cells and wiring information describing positions of arrangement position determined wiring lines arranged in corresponding to said plurality of relative position determined cells;
determining coordinates of said plurality of relative arrangement position determined cells in said IC chip based on said relative position information;
determining wiring routes of said arrangement position determined wiring lines in said IC chip based on said coordinates and said wiring information; and
determining an arrangement position of an arrangement position undetermined cell in said IC chip,
wherein said arrangement position undetermined cell is a cell of which arrangement position in said IC chip is undetermined in advance.

2. The layout design method according to claim 1, wherein said soft macro includes wiring prohibited area information, and
said determining said arrangement position of said arrangement position undetermined cell includes:
determining said arrangement position of said arrangement position undetermined cell and a wiring route of a wiring line such that said arrangement position of said arrangement position undetermined cell is not included in a wiring prohibited area described by said wiring prohibited area information and said wiring route of said wiring line bypasses said wiring prohibited area.

3. The layout design method according to claim 1, wherein said soft macro includes shielding line information and,
said determining said wiring routes of said arrangement position determined wiring lines includes:
determining wiring routes of shielding lines for suppressing influences of said arrangement position determined wiring lines on another net based on said shielding line information.

4. The layout design method according to claim 1, further comprising:
determining a position of a decoupling capacitor for said arrangement position determined wiring lines based on decoupling capacitor information included in said soft macro.

5. The layout design method according to claim 1, wherein said plurality of relative arrangement position determined cells includes a macro cell and an input/output (I/O) cell,
said determining said coordinates of said plurality of relative arrangement position determined cells includes:
determining coordinates of said macro cell and said I/O cell in said IC chip based on said relative position information, and
said determining said wiring routes of said arrangement position determined wiring lines includes:
determining a wiring route of a wiring line for connecting said macro cell and said I/O cell in said IC chip based on said wiring information and said coordinates of said macro cell and said I/O cell.

6. The layout design method according to claim 1, wherein said plurality of relative arrangement position determined cells include an input/output (I/O) macro,
said determining said coordinates of said plurality of relative arrangement position determined cells includes:
determining coordinates of said I/O macro in said IC chip based on said relative position information, and
said determining said wiring routes of said arrangement position determined wiring lines includes:
determining a wiring route of a wiring line connected to said I/O macro in said IC chip based on said wiring information and said coordinates of said I/O macro.

7. A method for generating a library, comprising:
reading a macro netlist describing circuit information on a macro and macro timing information describing operation timing of said macro;
determining a layout of said macro based on said macro netlist and said macro timing information;
specifying a critical path as a path of said macro, in which signal delay is large, based on said layout of said macro and said timing information;
extracting relative arrangement position determined cells as a plurality of functional cells included in said critical path;
generating relative position information and wiring information respectively describing relative positions of said relative arrangement position determined cells and wiring lines arranged in corresponding to said relative position determined cells; and
generating a soft macro library which includes said relative position information and said wiring information.

8. The method for generating a library according to claim 7, wherein said generating said relative position information and said wiring information includes:
generating wiring prohibited area information describing a wiring prohibited area in which a wiring line other than a wiring line arranged between one and another of said relative arrangement position determined cells is prohibited from being arranged, and
said soft macro library is generated to include said wiring prohibited area information in said generating said soft macro library.

9. The method for generating a library according to claim 7, wherein said generating said relative position information and said wiring information includes:
generating shielding line information describing shielding lines for suppressing influences of said wiring lines arranged in corresponding to said relative position determined cells on another net, and
said soft macro library is generated to include said shielding line information in said generating said soft macro library.

10. The method for generating a library according to claim 7, wherein said generating said relative position information and said wiring information includes:
generating decoupling capacitor information describing decoupling capacitors for reducing influence of said relative arrangement position determined cells on other functional cells and influence of other functional cells on said relative arrangement position determined cells, and
said soft macro library is generated to include said decoupling capacitor information in said generating said soft macro library.

11. A computer-readable medium which records a data structure of a soft macro for automated layout design of a semiconductor integrated circuit, wherein said data structure includes:
relative arrangement position determined cell information specifying relative arrangement position determined cells of which relative arrangement positions are determined in advance;
cell arrangement position relative coordinate information describing said relative arrangement positions;
wiring position determined net information specifying wiring position determined nets of which relative wiring positions are determined in corresponding to said relative arrangement position determined cells in advance; and
wiring position relative coordinate information describing said relative wiring positions,
said data structure is configured such that a computer operates according to an automated layout program to execute an automated layout design method of a semiconductor integrated circuit to be formed in an integrated circuit (IC) chip by using said data structure, and
said automated layout design method includes:
determining arrangements of said relative arrangement position determined cells in said IC chip based on said arrangement position determined cell information and said cell arrangement position relative coordinate information; and
determining wiring routes of said wiring position determined nets based on said wiring position determined net information and said wiring position relative coordinate information.

12. The computer-readable medium according to claim 11, wherein said data structure includes:
wiring prohibited area information describing a wiring prohibited area in which a wiring line other than said arrangement position determined nets is prohibited from being arranged, and
said automated layout design method includes:
determining a wiring route of said wiring line other than said arrangement position determined nets such that said wiring route bypasses said wiring prohibited area.

13. The computer-readable medium according to claim 11, wherein said data structure includes:
shielding line information describing shielding lines provided for said wiring position determined nets, and
said automated layout design method includes:
determining wiring routes of said shielding lines such that said shielding lines shield said wiring position determined nets based on said shielding line information.

14. The computer-readable medium according to claim 11, wherein said data structure includes:
decoupling capacitor information describing decoupling capacitors for reducing influence of said relative arrangement position determined cells on other functional cells or/and influence of other functional cells on said relative arrangement position determined cells, and
said automated layout design method includes:
determining positions of said decoupling capacitors based on said decoupling capacitor information.
